(19) United States
(12) Patent Application Publication
(10) Pub. No.: US 2014/0222697 A1
(43) Pub. Date: Aug. 7, 2014

(54) SYSTEM AND METHOD OF OBJECTIVELY ASSESSING PROPERTIES FOR PROSPECTIVE PURCHASERS

(71) Applicant: Patrick John Maiani, Montecito, CA (US)

(72) Inventor: Patrick John Maiani, Montecito, CA (US)

(21) Appl. No.: 14/175,671

(22) Filed: Feb. 7, 2014

Related U.S. Application Data
(60) Provisional application No. 61/850,010, filed on Feb. 7, 2013.

(51) Int. Cl. G06Q 50/16; G06Q 30/02

(52) U.S. Cl. CPC G06Q 50/16; G06Q 30/0282
USPC 705/313

(57) ABSTRACT

A system is provided for assessing properties for prospective purchasers. The system is a web based system that implements a method comprising the steps of: evaluating the location desirability of each property based upon pre-determined criteria and a graphical rating system, such as a five star rating system and assigning specified graphical rating to the property; evaluating the quality and number of amenities of each property based upon predetermined criteria and a numerical scale and assigning a numerical rating to the property; and simultaneously displaying the graphical rating and the numerical rating for at least selected ones of the properties to prospective purchasers.

### RELATED APPLICATIONS

This application claims priority to U.S. provisional patent application Ser. No. 61/850,010 filed Feb. 7, 2013, invented by Patrick John Maiani.

### BACKGROUND OF THE INVENTION

1. Field of the invention

The present invention relates to a system and method of objectively assessing properties, such as residential properties, for prospective purchasers to assist both prospective purchasers and sellers to reach a mutually beneficial transaction.

2. Background Information

The much discussed United States housing market remains both a cornerstone of the United States economy and a barometer for the health and prognosis of the U.S. Economy. For illustration, consider that in the fourth quarter of 2012 close over 5 million new and existing homes were sold, with about 4.9 million being existing homes (according to the U.S. Department of Housing and Urban Development's Office of Policy Development and Research). With an average price of new construction about $290,000 and an average price of existing home sales being about $228,000, it is immediately apparent the significance of this market.

Despite the large numbers of transactions, buying and selling residential real estate remains a relatively complex matter. At first it might seem that with the internet and a range of “for sale by owner” options, it may be easy in today's digital age for owners to sell their own home, but in real estate not only are all properties unique but so are neighborhoods and the requirements and tastes of sellers and buyers. Further adding to the mix is that about 30% of the buyers are first time home buyers, whom, as expected, are unfamiliar with the myriad of details to review in searching for and buying a house.

A number of tools have been provided to assist the buyers and sellers and their agents in attempting to target a collection of suitable houses to the relevant selection of potential purchasers. One of the most well known is known as the MLS listing, with MLS standing for Multiple Listing Service. The MLS listing is generally a regionally based complex database of listings entered directly by real estate professionals. The database is intended to act as a trading platform to buy and sell real estate properties. When a property is on the market for sale it is added to the database and tracked through the sales transaction cycle—for example, when an offer is accepted by the seller and the property closes escrow (known as a “status change”). All this information provides a real-time data base for real estate professionals, and their clients, to know precisely when a property is available for sale at any given moment and precisely when a property sells and for what price. Interestingly, the regional MLS listing is the very source that provides the data that feeds for real estate search sites like Zillow™, Trulia™, and REALTOR.COM®.

The MLS listing, and similar databases, allow for users to search available properties and to filter by designated criteria, E.G., price, number of bedrooms, number of bathrooms, etc. However the sites do not provide simple means for comparing properties within such a search which can overwhelm purchasers, particularly first time buyers. For example in the market of Houston Texas one site was listing about 5,000 homes for sale in one publically available database. Supplying relatively tight filters of a reasonable price range and minimum bedroom number and minimum bathroom number for a potential buyer yielded over 600 homes remaining. It is not likely that the buyer would carefully inspect all 600 properties that met this buyers fundamental criteria and such a buyer is left with arbitrarily restricting the search further than intended to reach a manageable number that can be reviewed individually. The end result is arbitrarily culling a large number of potential houses from the buyer's review that would meet his basic criteria and may ultimately be more preferable to the buyer than those he ends up inspecting (and buying).

With this background it becomes clear that for residential properties there is a need for objectively evaluating a number of residential properties relative to each other for potential purchasers that is easy for the potential purchasers to utilize and understand.

### SUMMARY OF THE INVENTION

The present invention addresses the deficiencies of the prior art and provides a system for assessing properties, such as (but not limited to) residential properties, for prospective purchasers. Residential properties within the meaning of this application references single family homes, duplexes, triplexes, condominiums, mobile homes, developed and undeveloped land, and generally any real estate other that commercial real estate. Properties will encompass residential and commercial properties.

One aspect of the invention provides a method comprising the steps of: evaluating the location desirability of each property based upon pre-determined criteria and a graphical based rating system, such as a five star rating system, and assigning specified graphical rating to the property; evaluating the quality and number of amenities of each property based upon predetermined criteria and a numerical scale and assigning a numerical rating to the property; and simultaneously displaying the graphical rating and the numerical rating for at least selected ones of the properties to prospective purchasers.

One aspect of the present invention provides a web based system for objectively assessing properties for prospective purchasers comprises a database having an assigned graphical rating for each property, wherein the system is configured to evaluate the location desirability of each property based upon predetermined criteria and a graphical based rating system, such as a five star rating system, and to assign the specified graphical rating to the property; wherein the database has a numerical rating assigned to the property, wherein the system is configured to evaluate the quality and number of amenities of each property based upon predetermined criteria and a numerical scale and to assign the numerical rating to the property; and wherein a series of user devices are selectably connectable to the database, wherein the system is configured to simultaneously display on the user device the graphical rating, such as a star rating, and the numerical rating for at least selected ones of the properties to prospective purchasers.

One aspect of the invention provides a web based system for objectively assessing properties for prospective purchasers which comprises a database having a numerical rating assigned to the property, wherein the system is configured to evaluate the quality and number of amenities of each property based upon predetermined criteria and a numerical scale and to assign the numerical rating to the property; and wherein a series of user devices are selectably connectable to the database, wherein the system is configured to display on the user device the numerical rating for at least selected ones of the properties to prospective purchasers.

These and other advantages are described in the brief description of the preferred embodiments in which like reference numeral represent like elements throughout.

### BRIEF DESCRIPTION OF THE FIGURES

FIG. 1A is schematic representation of a web based system for assessing residential properties for prospective purchasers in accordance with one aspect of the present invention;

FIGS. 1B-D are schematic representations of screenshots of the web based system for assessing residential properties for prospective purchasers in accordance with one aspect of the present invention; and

FIGS. 2-31 are schematic representations of charts of sample prospective property amenity variables and prospective weighting values utilized assessing residential properties for prospective purchasers in accordance with one aspect of the present invention.

### DESCRIPTION OF THE PREFERRED EMBODIMENTS

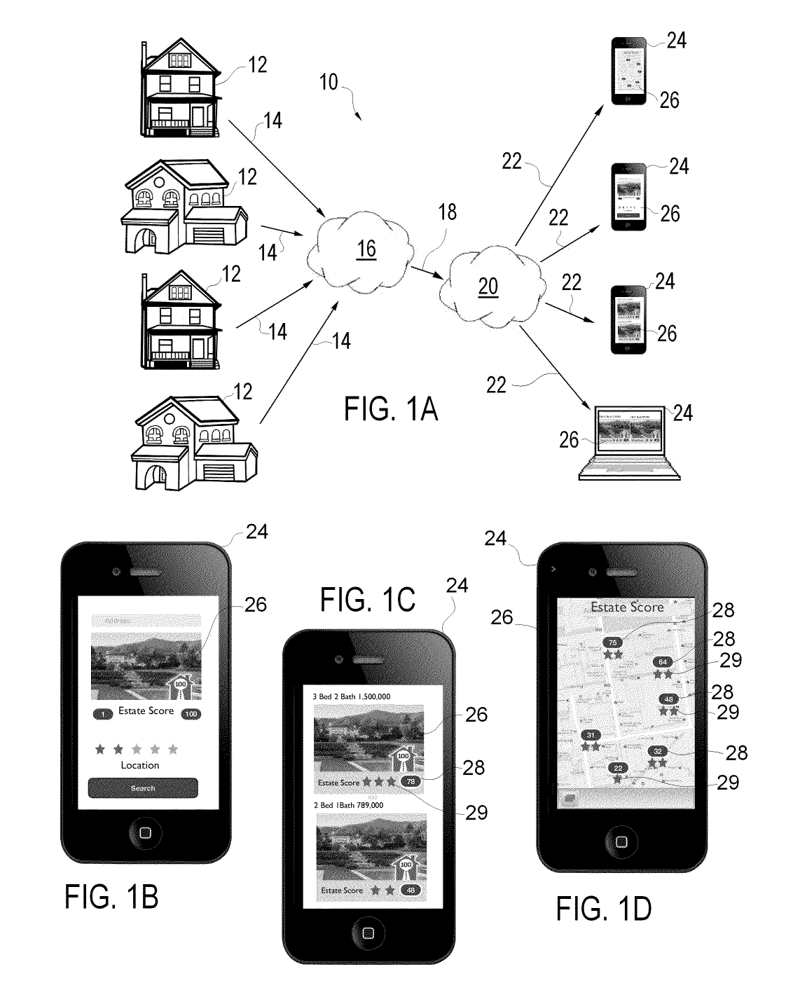

FIG. 1A is schematic representation of a web based system 10 for assessing properties, such as for illustration residential properties 12, for prospective purchasers in accordance with one aspect of the present invention. The web based system 10 may be referenced herein as the ESTATE SCORE™ assessment or rating system. The system 10, as described in detail below is based on the combination for properties 12 of i) a graphical rating, namely a 1-5 star rating 29, for property location and ii) a 0-100 numeric value 28 to rate the home's amenities and quality and size etc. The numerical rating 28 of a particular home 12 allows any potential purchaser to obtain an objective (starred and numerical) rating of its location and qualities without ever having to see or know anything about the home 12 except its ESTATE SCORE™ assessment. Residential properties 12 within the meaning of this application references single family homes, duplexes, triplexes, condominiums, mobile homes, developed and undeveloped land, and these terms may be used generally interchangably. Properties references both commercial properties and residential properties.

The system 10 is applicable for use by a variety of devices 24 including but not limited to all personal or lap top computers, notebooks, desktops, tablets, smart phones, PDA's, other hand held devices, kiosks, or any other similar net accessing technologies.

As will be apparent from the following description the seller, or agent, (or buyer if the house 12 is a for-sale by owner situation and the specs of a property 12 are not already inputted into a database 16) can input via connection 14 using any associated device 24, the information for any given house 12 into a database 16, such as an existing MLS listing database. The computer website or application 20 will couple to the database 16 via connection 18 and consider each amenity or quality inputted according to an objective predetermined algorithm and generate a score 0-100 as well as the location. The system 10 will generate an objective assessment, also called an ESTATE SCORE™ rating which can now be used to describe, display and sort the property 12.

The web based system 10 may have a website 20 with the associated property ratings thereon or it may have the only the predetermined rating algorithm that generates specific ratings from user requests wherein it applies the predetermined rating algorithms to property specifics pulled from an existing database 16 via coupling 18 and sends the results directly to the user devices 24 for display 26. Alternatively the web based system 10 may be constructed to move the application 20 to each device 24 as a downloadable application and the device based application 20 may have the associated property ratings (28, 29) thereon or it may have the only the predetermined rating algorithm that generates specific ratings (28, 29) from user requests wherein it applies the predetermined rating algorithms to property specifics pulled from an existing database 16 via coupling 18. Thus the element 20 may be referenced interchangeably herein as a website or application, and the system 10 may also form element 20 to be a mix of a website and a downloadable application portion.

The web based system 10 for objectively assessing properties for prospective purchasers comprises a website or app 20 with an evaluation protocol or a database having an assigned star rating 29 for each property, wherein the system 10 is configured to evaluate the location desirability of each property 12 based upon predetermined criteria and a five star rating system and to assign the specified star rating 29 to the property 12. The system 10 provides that the database has a numerical rating 28 assigned to the property 12, wherein the system 10 is configured to evaluate the quality and number of amenities 30 of each property 12 based upon predetermined criteria and a numerical scale and to assign the numerical rating 28 to the property 12. The system 10 provides that a series of user devices 24 are selectably connectable to the database (also called the website 20 or the app 20) via connection 22, wherein the system 20 is configured to simultaneously display 26 on the user device 24 the graphical rating, such as the star rating 29, and the numerical rating 28 for at least selected ones of the properties 12 to prospective purchasers.

The graphical rating is preferably a star rating 29 which may effectively be a five star rating system with five stars being the most desirable location and no stars being the least desirable location. This graphical system is immediately understood by novice users. Other graphical systems may be used such as a check based system (e.g., check minus, check and check plus), a color coded system (e.g., red to green), however the star based system seems to be particularly easy to understand by novice users. The delineation in rank or levels within the five star rating system for rating 29 is preferably by ½ stars, as lesser delineations may become cumbersome or viewing.

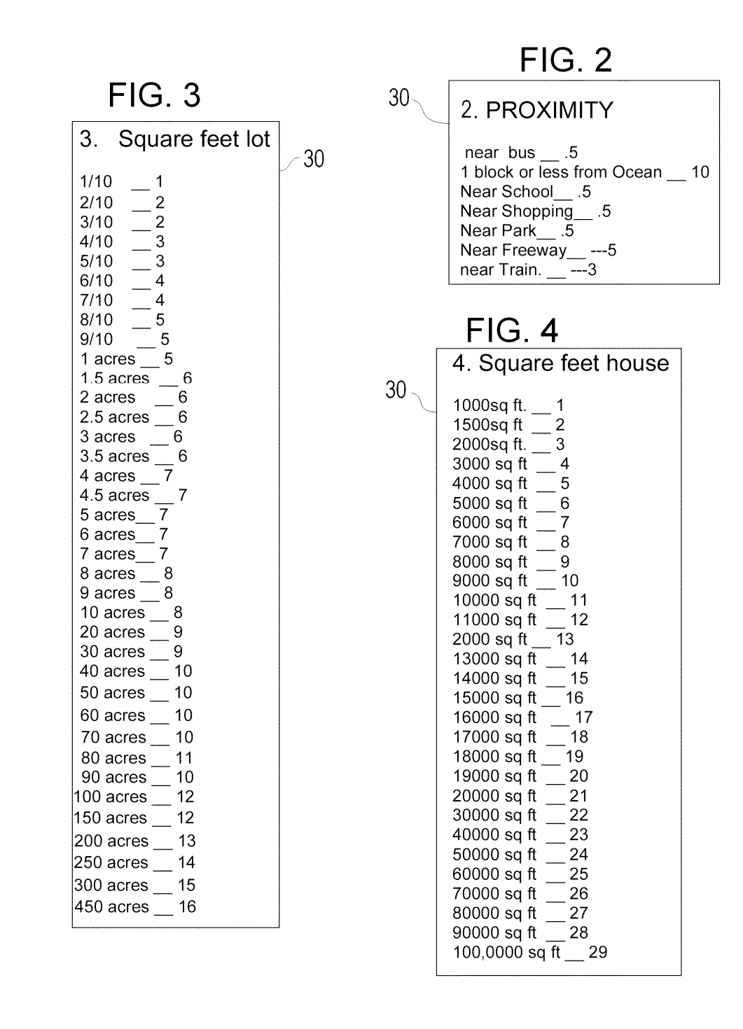

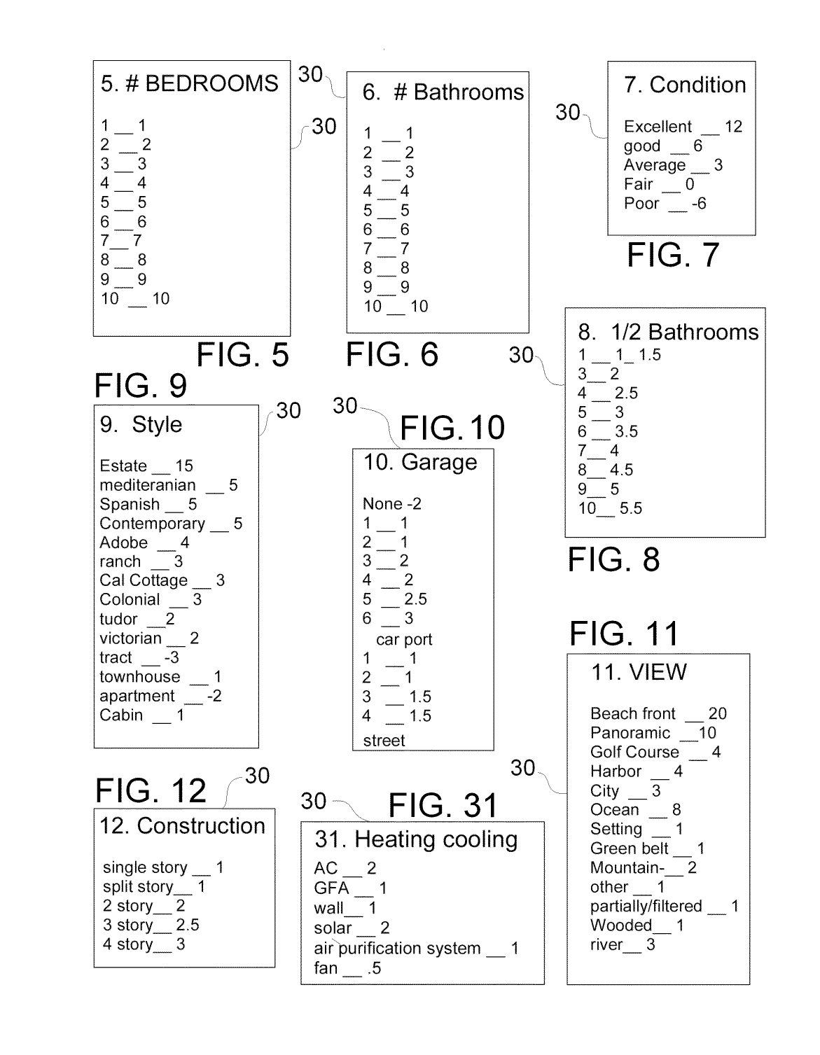

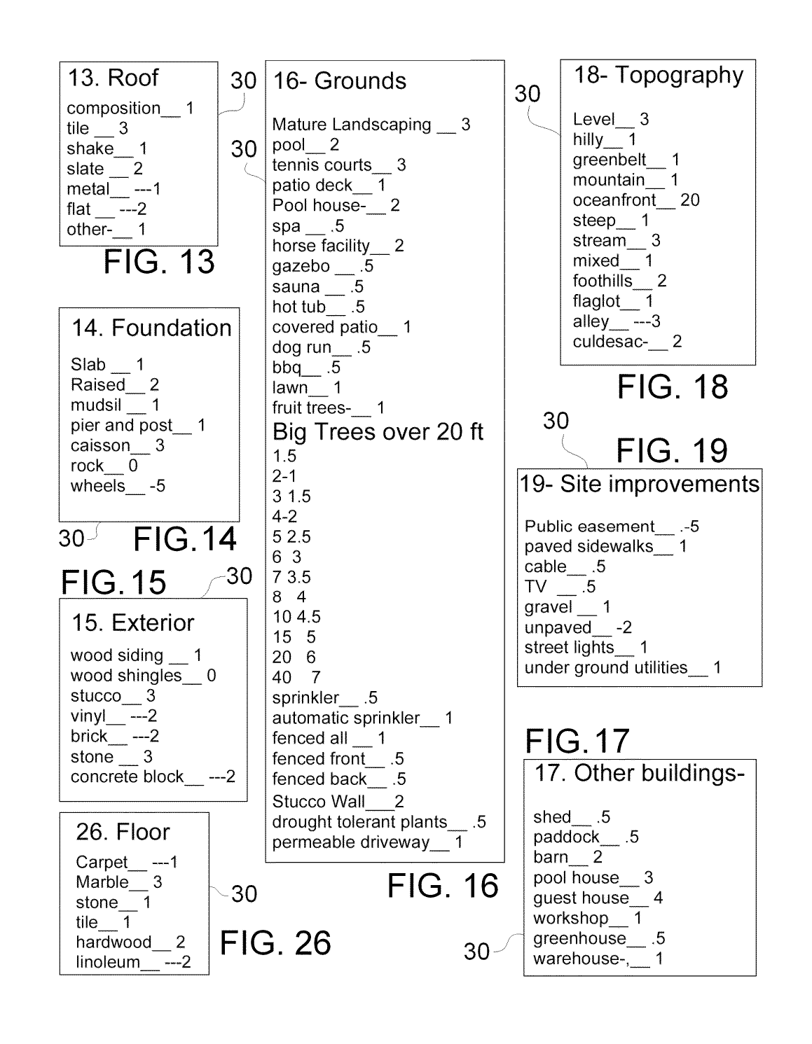

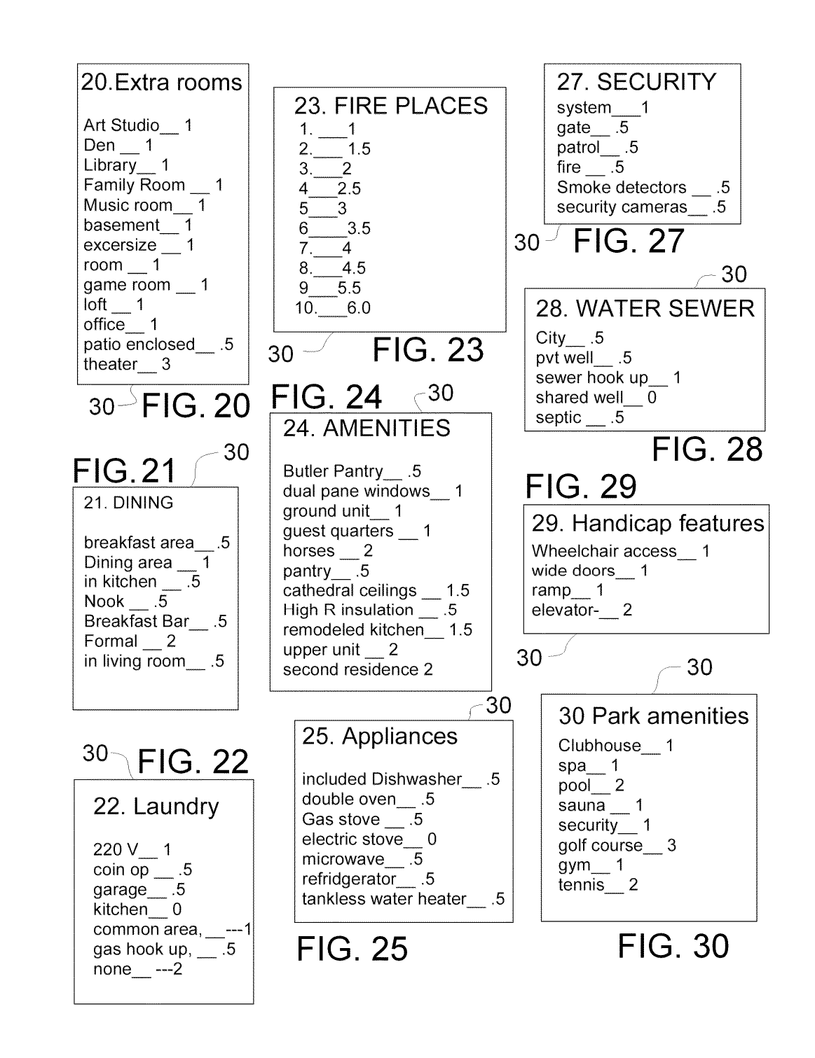

The numerical scale is from 0-100 with higher numbers associated with increasing quality and number of amenities. Like the star system for location, this system for the quantity and quality of amenities 30 is easily understood by users. The delineation in rank or levels within the numerical rating system is preferably by integers, again for ease of display. FIGS. 2-31 are schematic representations of charts of sample prospective property amenities 30, or variables used to construct the numerical rating 28, and prospective weighting values utilized assessing residential properties 12 for prospective purchasers in accordance with one aspect of the present invention. These particular amenities and weights are for illustration only. Further, the actual weighting and relative values of select property amenities will certainly be regionally dependent. A key feature of the present invention is that real estate professionals will determine the consideration and weighted values of the amenities listing for developing an objective weighing of the quantity and quality of amenities 30 for calculating a score 28. In summary to develop the algorithm for generating the score 28, the specific amenities considered for the score must be selected. In other words, some amenities of a property may not have any value or consideration in developing the score. For each amenity that will be considered in the score 28 a rating system/point range for that amenity must be selected, examples of which are shown in FIGS. 2-31. Then the weight of each amenity category must be determined and the resulting score scaled to the desired range (i.e. 0-100). It is possible to set up the system such that point range for each category accommodates the relative weighting of that category such that the system need only add up the values for each amenity. As the system 10 calculates the score 28 behind the scenes there can be many distinct mathematical formula followed to generate the end rating score 28, as the user need to follow the particular composite score calculation.

As described above, it is preferable if the system 10 for objectively assessing properties for prospective purchasers is completely internet accessible. Further, although the database 16 may be integrated with the website/application 20, it is preferable if the evaluations of the properties 12 performed by the system 10 utilize data from a real estate property database 16 such as a MLS listing.

Further in the web based system 10 for objectively assessing properties, such as residential properties 12, for prospective purchasers, the display 26 of the evaluations may be filtered by the user by the numerical rating 28 to only display properties 12 having a numerical rating 28 within a desired range or above or below a desired threshold. Alternatively, the display 26 of the evaluations may be filtered by the user by the star rating 29 to only display properties 12 having a star rating 29 within a desired range or above or below a desired threshold. Similarly, the display 26 of the evaluations may be filtered by the user by one or more of the amenities 30 of each property to only display properties having a numerical value for the one or more specified amenities within a desired range or above or below a desired threshold.

The display 26 which simultaneously displays the star rating 29 and the numerical rating 28 for at least selected ones of the properties 12 to prospective purchasers may be in a map format showing multiple results, maybe in a chart format, or may be associated with display format/pictures of select homes 12. Samples of such display formats are shown in FIGS. 1B-D. Further the display format may simply be an overlay onto an existing real estate display option for a property.

The web based system 10 for objectively assessing properties, such as residential properties 12, for prospective purchasers may further be configured to allow a user to modify the predetermined criteria associated with the numerical scale 28 and or the star rating 29 and to reassign a subjective numerical rating 28 and or star rating 29 to at least selected properties based upon the user modified criteria. This modification will allow users who utilize the system to, once they become familiar with the system 10, to tweak the system to their preferences. The ability to create subjective ratings may be a tool best suited for real estate professionals who feel comfortable adjusting the system weightings for their or their client's taste. Even with subjective evaluations the system 10 provides an effective method of merging and consolidating a large amount of data for effective review by potential purchasers.

The ESTATE SCORE™ brand system 10 described above is preferably available to agents and home owners on the internet as a URL webpage or in the App Store for iOS, Android and other Smartphone platforms. In operation the ESTATE SCORE™ brand system 10 will guide users with instructions on how to use the product. On the seller side an agent simply uploads all a home's amenities and location to a database 18, e.g. a MLS listing. The system 10 connects to the database, via connection 18, and the unique predetermined algorithm calculates a unique score between 0-100, coupled with a graphical rating, namely the 5-star rating for location and assigns this rating to the property 12 in the website 20. The buyer or customer or agent therefore may filter the selection of houses by picking a number or a range of numbers between 0-100 and/or may use the star ratings for such filtering. For example: all homes between 70-80 or everything under 35 in a 2-star location.

All data for the system 10 and the associated website 20 will be securely stored in a database behind a firewall. Sensitive information such as passwords will be encrypted.

In conclusion the web based system 10, and associated method, provide for objectively assessing properties for prospective purchasers to assist both prospective purchasers and sellers to reach a mutually beneficial transaction and is based on an easily understood graphical rating system, such as star rating (1-5 stars) for location desirability coupled with an equally easily understood 0-100 numerical point value rating homes based on a number of qualities and amenities, such as square footage, views, number of beds and baths, etc. An example of a calculated assessment, also called an ESTATE SCORE™, for a property 12 would be: ***75.

The ESTATE SCORE™ rating system 10 provides valuable shorthand to buyers and sellers of homes 12, independent of dollar value for the property. Accessible via the internet, users could, for example, input an address and the system 10 will pull information from an associated data base, e.g., an MLS listing, and objectively score the amenities and qualities to give the total ESTATE SCORE™ assessment of that property. The system 10 is essentially a scoring system for real estate properties of all types, including estates, houses, townhouses, duplexes, condos, mobile homes, commercial properties, land, etc. Buyers will benefit from an added method of evaluating homes 12. Buyers will be able to find houses that match their desires more quickly and easily. ESTATE SCORE™ system users (or customers) will be able to get a feel for a home's quality without having to sort through pictures, and thus can more quickly evaluate a larger collection of homes 12. A star rating 29 for location mixed with a numerical score 28 creates a more specific way of purchasers finding desired homes 12. The system 10 and associated method are described in connection with all properties, but have particular application in residential properties wherein there are a large number of first time buyers who are less sophisticated and must try and consider an overwhelming number of amenities.

The preferred embodiments described above are illustrative of the present invention and not restrictive hereof. It will be obvious that various changes may be made to the present invention without departing from the spirit and scope of the invention. The precise scope of the present invention is defined by the appended claims and equivalents thereto.

What is claimed is:

1. A method of assessing properties for prospective purchasers comprising the steps of:
Evaluating the location desirability of each property based upon pre-determined criteria and a graphical rating system and assigning specified graphical rating to the property;
Evaluating the quality and number of amenities of each property based upon predetermined criteria and a numerical scale and assigning a numerical rating to the property; and
Simultaneously displaying the graphical rating and the numerical rating for at least selected ones of the properties to prospective purchasers.

2. The method of assessing properties for prospective purchasers according to claim 1 wherein the graphical rating is a five star rating system with five stars being the most desirable location and no stars being the least desirable location.

3. The method of assessing properties for prospective purchasers according to claim 2 wherein the delineation in rank within the five star rating system is by ½ stars.

4. The method of assessing properties for prospective purchasers according to claim 2 wherein the numerical scale is from 0-100 with higher numbers associated with increasing quality and number of amenities.

5. The method of assessing properties for prospective purchasers according to claim 4 wherein the properties are residential properties and wherein the evaluations of the properties are internet accessible.

6. The method of assessing properties for prospective purchasers according to claim 4 wherein the evaluations of the properties utilize data from a real estate property database.

7. The method of assessing properties for prospective purchasers according to claim 4 wherein display of the evaluations may be filtered by the user by the numerical rating to only display properties having a numerical rating within a desired range or above or below a desired threshold.

8. The method of assessing properties for prospective purchasers according to claim 4 wherein display of the evaluations may be filtered by the user by the graphical rating to only display properties having a graphical rating within a desired range or above or below a desired threshold.

9. The method of assessing properties for prospective purchasers according to claim 4 wherein display of the evaluations may be filtered by the user by one or more of the amenities of each property to only display properties having a numerical value for the one or more specified amenities within a desired range or above or below a desired threshold.

10. The method of assessing properties for prospective purchasers according to claim 4 further including the step of allowing a user to modify the predetermined criteria associated with the numerical scale and reassigning a numerical rating to at least selected properties based upon the user modified criteria.

11. A web based system for objectively assessing properties for prospective purchasers comprising:
a database having an assigned graphical rating for each property, wherein the system is configured to evaluate the location desirability of each property based upon predetermined criteria and a graphical star rating system and to assign the specified graphical rating to the property;
wherein the database has a numerical rating assigned to the property, wherein the system is configured to evaluate the quality and number of amenities of each property based upon predetermined criteria and a numerical scale and to assign the numerical rating to the property; and
wherein a series of user devices are selectably connectable to the database, wherein the system is configured to simultaneously display on the user device the graphical rating and the numerical rating for at least selected ones of the properties to prospective purchasers.

12. The web based system for objectively assessing properties for prospective purchasers according to claim 11 wherein the graphical rating is a five star rating system with five stars being the most desirable location and no stars being the least desirable location.

13. The web based system for objectively assessing properties for prospective purchasers according to claim 12 wherein the delineation in rank within the five star rating system is by ½ stars.

14. The web based system for objectively assessing properties for prospective purchasers according to claim 12 wherein the numerical scale is from 0-100 with higher numbers associated with increasing quality and number of amenities.

15. The web based system for objectively assessing properties for prospective purchasers according to claim 14 wherein the evaluations of the properties are internet accessible.

16. The web based system for objectively assessing properties for prospective purchasers according to claim 14 wherein the evaluations of the properties utilize data from a real estate property database.

17. The web based system for objectively assessing residential properties for prospective purchasers according to claim 14 wherein display of the evaluations may be filtered by the user to only display properties having a a selected rating or amenity within a desired range or above or below a desired threshold.

18. A web based system for objectively assessing properties for prospective purchasers comprising:
a database having a numerical rating assigned to the property, wherein the system is configured to evaluate the quality and number of amenities of each property based upon predetermined criteria and a numerical scale and to assign the numerical rating to the property; and
wherein a series of user devices are selectably connectable to the database, wherein the system is configured to display on the user device the numerical rating for at least selected ones of the properties to prospective purchasers.

19. The web based system for objectively assessing properties for prospective purchasers according to claim 18 wherein display of the numerical ratings may be filtered by the user by one or more of the amenities of each property to only display properties having a numerical value for the one or more specified amenities within a desired range or above or below a desired threshold.

20. The web based system for objectively assessing properties for prospective purchasers according to claim 18 further including the system configured to allow a user to modify the predetermined criteria associated with the numerical scale and reassigning a numerical rating to at least selected properties based upon the user modified criteria.
